(19) United States
(12) Patent Application Publication
(10) Pub. No.: US 2005/0044368 A1
(43) Pub. Date: Feb. 24, 2005

(54) Method for protecting a computer system

(75) Inventors: Georg Ahn, Augsburg (DE); Markus Braun, Munningen (DE)

Correspondence Address: COHEN, PONTANI, LIEBERMAN & PAVANE, 551 FIFTH AVENUE, SUITE 1210, NEW YORK, NY, 10176, US

(73) Assignee: Fujitsu Siemens Computers GmbH, Munchen (DE)

(21) Appl. No.: 10/914,459

(22) Filed: Aug. 9, 2004

(30) Foreign Application Priority Data
Aug. 7, 2003 (DE) 103 36 246.0

(51) Int. Cl. H04L 9/00

(52) U.S. Cl. 713/172

(57) ABSTRACT

A method for protecting a computer system (1) having a choice of various users (3, 4) with various authorizations (3a, 4a), having at least one interface (2) for interchanging data with at least one internal or external peripheral device (5), where the interface (2) is active when the peripheral device (5) has authorization or when the authorization (3a, 4a) of the current user (3, 4) activates the interface (2).

### RELATED APPLICATIONS

This patent application claims the priority of German patent application no. 103 36 246.0 filed Aug. 7, 2003, the disclosure content of which is hereby incorporated by reference.

### FIELD OF THE INVENTION

The invention relates to a method for protecting a computer system having a choice of various users, with various authorizations, having at least one interface for interchanging data with at least one internal or external peripheral device.

### BACKGROUND OF THE INVENTION

Interfaces on computer systems are used for connecting peripheral devices to the computer system in order to operate these peripheral devices with the computer system. Examples of these peripheral devices are data drives, scanners, printers, other computers etc.

The increasing standardization of interfaces, allowing a wide variety of devices to be connected to one and the same interface alternately or even in parallel, is making it increasingly difficult to protect computer systems against unauthorized access by, or using, these standardized interfaces. In addition, modern operating systems often afford the opportunity to use interfaces even when they have not been enabled by the “BIOS”, the computer's Basic Input/Output System, which acts as an interface between the hardware and the operating system. This applies both to physical interfaces and to logical interfaces. Physical interfaces mean any plug or socket on a computer system, and a logical interface is to be understood to mean, by way of example, the division of a hard disk into different partitions, each partition being able to be addressed as a separate drive within an operating system using a logical interface. Since these drives are physically located on a hard disk and are not real drives, they are called virtual drives. This requires logic, for example in the form of software, within the operating system which identifies and operates these two partitions as different drives. This is an example of a logical interface.

If a computer system can be accessed by a plurality of users, who may have different authorizations when using this computer system, then each individual user can be provided with a different system resource in the computer system through the allocation of authorizations. However, problems arise when allocating authorizations in relation to the aforementioned interfaces. In this case, it is often not possible to assign the use of interfaces, for example USB, to a user.

### SUMMARY OF THE INVENTION

One object of the invention is to protect a computer system against unauthorized access while avoiding the aforementioned drawbacks.

This and other objects are attained in accordance with one aspect of the invention directed to a method for protecting a computer system having a choice of various users with various authorizations, having at least one interface for interchanging data with at least one internal or external peripheral device, where the interface is active when the peripheral device has authorization or when the authorization of the current user permits activation of the interface.

What is advantageous about the inventive method is that authorizations for activating the interface are required before the interface is activated. That is to say that if the current user does not have authorization to use the interface then the interface is not activated. The user is therefore unable to connect a device to this interface and to operate it. Similarly, a device which is intended to be operated on an interface needs to be known to the computer system to a certain extent, and the computer system needs to identify authorization for this device to be operated on the interface. The invention allows these two variants to be used and combined selectively.

The method is, in principle, suitable not just for physical interfaces, such as the interface for a hard disk, a scanner, a printer, a USB port or the like, but is likewise suitable for logical interfaces, such as the interface for logical hard disk partitions which can be addressed as separate drives by the operating system.

There are various suitable options for conveying the authorizations for the users of the computer system. In one advantageous embodiment, the invention provides for the authorization to be stored on an external device and for this device to be connected to the computer when required. The computer system takes information about the current user from the external device, which may be a chip card, for example, and thus assigns the authorization for various system resources in the computer system to the current user. These also include the authorization for the interface. If the external device contains information identifying authorization for the current user to use the interface, then the interface is activated.

Suitable external devices other than chip cards are any other electronic devices which a user carries about his person and which can be connected to the computer system. This is, by way of example, a mobile telephone, a PDA and the like. The connection to this device can be made in various ways which are part of the general prior art and not of this invention. Hence, a connection to this device can be made using radio links or using wire-based links.

The way in which the interface is activated or deactivated is dependent upon whether it is a physical interface or a logical interface. In the case of a physical interface, the invention proposes the following, for example: deactivation or activation of control electronics which control the computer system's data interchange with the peripheral device which is connected to the interface by means of a plug contact. The invention also proposes deactivating or activating the wire-connected interface by means of switching contacts, which may also be in electronic form, so that data cannot be interchanged with a connected device. In the case of a logical interface, a software-based logical interface controller needs to be activated or deactivated in order to activate or deactivate the interface.

The invention is explained in more detail below with the aid of an exemplary embodiment.

### BRIEF DESCRIPTION OF THE DRAWINGS

FIG. 1 shows a schematic block diagram of an apparatus for implementing the method with various users,

FIG. 2 shows a schematic block diagram of an apparatus for implementing the method with authorized peripheral devices.

### DETAILED DESCRIPTION OF THE DRAWINGS

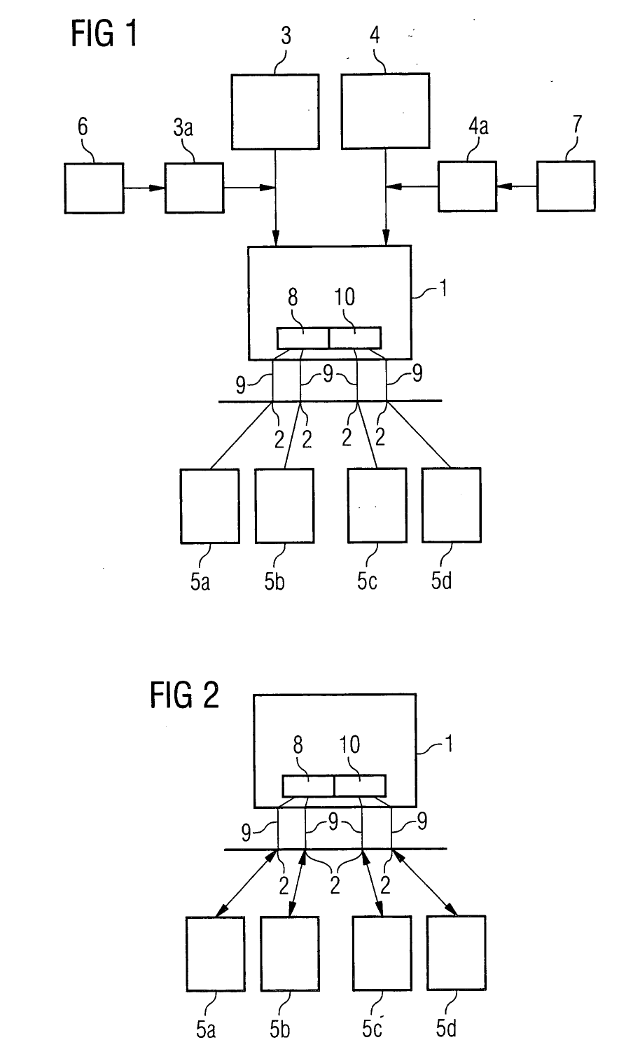

A computer system 1 shown in the center of FIG. 1 has an interface 2. A first user 3 or a second user 4 has access to the computer system 1 and to the peripheral devices 5a to 5d which are connected to the computer system 1 via the interface 2. Each of the two users 3 or 4 has different authorizations 3a or 4a, which he obtains via an external device 6 or 7 he carries, which he connects to the computer system. In this way, the user 3 or 4 conveys his authorizations 3a and 4a to the computer system. Interface 2 can be a single interface to which all the different peripherals are connected, or it can be representative of several interfaces respectively connected to different peripherals.

The authorizations 3a and 4a provide the computer system 1 with the information regarding whether or not the interface 2 needs to be activated for the current user. To activate the interface 2, the computer system activates control electronics 8 which undertake electronic actuation of the interface and hence of the connected peripheral device 5a to 5d. The activation or deactivation of the control electronics 8 thus results in the activation or deactivation of the peripheral device.

Each peripheral device 5a to 5d is connected to the computer system by means of a connecting line 9. This connecting line 9 is routed from the computer system 1 to the interface 2. There is thus another possible way of activating or deactivating the interface and hence the peripheral device 5a to 5d. In this example, this is done by simply disconnecting the connecting line 9, with manual or automatic switches or else electronic switches being suitable. Preferably, however, electronic switches will be used.

To activate or deactivate logical interfaces, such as two different partitions on hard disks which form two logical drives mapped on one physical drive, logical interfaces are required which in turn allow these two logical drives on the one physical drive to be addressed as two logical drives. This is illustrated by a logic controller 10 which performs the data interchange between the computer system 1 and the interface 2 and the logical peripheral devices 5c and 5d.

A peripheral device 5a to 5d which is connected to the computer system 1 via the interface 2 can thus be operated on the computer system 1 by the user 3 or 4 only with appropriate authorization 3a or 4a.

The activation and/or deactivation of the interface can be done in any one of many well known ways. For example, a “power on/off” switch or command can be used to activate and/or deactivate an electronic control circuit. For the software based logical interface, the program can be stopped/started, or it could be deleted from the memory or kept running in it. It is believed that such design engineering details are well within the capability of anyone with ordinary skill in the art, so providing details thereof herein is not deemed necessary.

FIG. 2 shows another exemplary embodiment, with the computer system 1 and with the interface 2 to which the peripheral device 5a to 5d can be connected. In this case, the authorization or the activation of the interface is not effected by the user and his authorization, but rather by means of registration of the peripheral device 5a to 5d on the computer system 1. When a peripheral device 5a to 5d is connected to the computer system 1, the peripheral device 5a to 5d conveys to the computer system 1 information which the peripheral device 5a to 5d uses to identify itself to the computer system 1. If the computer system 1 does not yet know this peripheral device 5a to 5d or if the peripheral device is not authorized to be operated on the computer system, the interface which performs the data interchange with this peripheral device is deactivated.

The first and second embodiments can be advantageously combined to increase the level of security. For example, a user having the authorization to use an interface may have a peripheral that is not permitted to be used with the computer system because there may be harmful software on it. By combining these embodiments, both the user's authorization and the peripheral's authorization will be checked. For example, first the user's authorization will be checked, and then that of the peripheral.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. A method for protecting a computer system (1) having a choice of various users (3, 4), with various authorizations (3a, 4a), having at least one interface (2) for interchanging data with at least one internal or external peripheral device (5), comprising:
providing to the computer system an authorization for at least one of a peripheral device (5) and a current user that permits activation of the peripheral device (2), and
activating the interface (2) only when said authorization has been received by the computer system.

2. The method as claimed in claim 1,
wherein
the interface (2) is a physical or logical interface.

3. The method as claimed in claim 2,
comprising:
storing the authorization is stored on an external device (6, 7) which can be connected to the computer system (1).

4. The method as claimed in claim 3,
wherein
the external device (6, 7) is a chip card, a Bluetooth device, a mobile telephone or a PDA.

5. The method as claimed in claim 4,
comprising:
activating the interface (2) by virtue of control electronics (8) in the computer system (1) being activated in order to control the operation of the interface (2).

6. The method as claimed in claim 1,
comprising
activating the interface (2) by virtue of connecting lines (9) to the interface (2) being closed.

7. The method as claimed in claim 1,
comprising:
activating the interface (2) by virtue of a logic controller (10) being activated in order to control the operation of a logical interface (2).

8. The method as claimed in claim 1,
comprising:
storing the authorization is stored on an external device (6, 7) which can be connected to the computer system (1).

9. The method as claimed in claim 8,
wherein
the external device (6, 7) is a chip card, a Bluetooth device, a mobile telephone or a PDA.

10. The method as claimed in claim 1,
comprising:
activating the interface (2) by virtue of control electronics (8) in the computer system (1) being activated in order to control the operation of the interface (2).

11. The method as claimed in claim 2,
comprising:
activating the interface (2) by virtue of control electronics (8) in the computer system (1) being activated in order to control the operation of the interface (2).

12. The method as claimed in claim 3,
comprising:
activating the interface (2) by virtue of control electronics (8) in the computer system (1) being activated in order to control the operation of the interface (2).

13. The method as claimed in claim 2,
comprising
activating the interface (2) by virtue of connecting lines (9) to the interface (2) being closed.

14. The method as claimed in claim 3,
comprising
activating the interface (2) by virtue of connecting lines (9) to the interface (2) being closed.

15. The method as claimed in claim 4,
comprising
activating the interface (2) by virtue of connecting lines (9) to the interface (2) being closed.

16. The method as claimed in claim 2,
comprising:
activating the interface (2) by virtue of a logic controller (10) being activated in order to control the operation of a logical interface (2).

17. The method as claimed in claim 3,
comprising:
activating the interface (2) by virtue of a logic controller (10) being activated in order to control the operation of a logical interface (2).

18. The method as claimed in claim 4,
comprising:
activating the interface (2) by virtue of a logic controller (10) being activated in order to control the operation of a logical interface (2).
